(19) United States
(12) Patent Application Publication
(10) Pub. No.: US 2024/0090092 A1
(43) Pub. Date: Mar. 14, 2024

(54) MULTILEVEL COOKING ACCESSORY FOR A COOKING SYSTEM

(71) Applicant: WHIRLPOOL CORPORATION, BENTON HARBOR, MI (US)

(72) Inventors: Annalisa PACIONI, Bresso (IT); Andrea GALLIVANONI, Casorate Sempione (IT); Alessandro MAGISTRELLI, Castellanza (IT)

(73) Assignee: WHIRLPOOL CORPORATION, BENTON HARBOR, MI (US)

(21) Appl. No.: 17/941,765

(22) Filed: Sep. 9, 2022

(51) Int. Cl. H05B 6/12; A47J 27/00; H05B 6/06

(52) U.S. Cl. CPC H05B 6/1236; A47J 27/004; H05B 6/062; H05B 2213/06

(57) ABSTRACT

A cooking system includes a support structure that has a support surface and a cooking device for placement on the support structure. A power transmission circuit is between the support structure and the cooking device. The power transmission circuit has a first power communication coil in the support structure, a second power communication coil in the cooking device, and a power source that is in communication with the first power communication coil. The first power communication coil is configured to induce an electrical current in the second power communication coil. A heat control circuit has a first heating device and a second heating device in the cooking device. The second heating device is disposed above the first heating device. A controller is configured to control a power level for the first and second heating devices.

### BACKGROUND OF THE DISCLOSURE

The present disclosure generally relates to a cooking system and, more specifically, to a wirelessly powered multilevel cooking accessory.

### SUMMARY OF THE DISCLOSURE

According to one aspect of the present disclosure, a cooking system includes a support structure that has a support surface. The cooking system further includes a cooking device for placement on the support structure. The cooking system further includes a power transmission circuit between the support structure and the cooking device. The power transmission circuit has a first power communication coil disposed in the support structure, a second power communication coil that is disposed in the cooking device, and a power source that is in communication with the first power communication coil. The first power communication coil is configured to induce an electrical current in the second power communication coil. The cooking system further includes a heat control circuit that includes a first heating device and a second heating device that are disposed in the cooking device. The second heating device is disposed above the first heating device. A controller is in communication with the first and second heating devices and is configured to control a power level for the first and second heating devices.

According to another aspect of the present disclosure, a wireless cooking accessory includes a housing having a base, a first support member, and a second support member. A power receiver coil is disposed in the base and is configured to receive electrical power via induction power transfer. A heat control circuit has a plurality of heating devices disposed in the housing and a controller that is in communication with the plurality of heating devices. The controller is configured to control a power level for each of the plurality of heating devices. The plurality of heating devices are arranged in a vertical array.

According to yet another aspect of the present disclosure, a system for a multilevel cooking accessory includes an induction cooktop that has a cooktop surface. A power transmission circuit is between the induction cooktop and the multilevel cooking accessory. The power transmission circuit includes a first power communication coil that is disposed in the induction cooktop and a second power communication coil that is disposed in the multilevel cooking accessory. A power source is in communication with the first power communication coil. The first power communication coil is configured to induce an electrical current in the second power communication coil. A heat control circuit is powered by the power transmission circuit and includes a first heating device and a second heating device that are disposed in the cooking device. The second heating device is disposed above the first heating device. A controller is in communication with the first and second heating devices and is configured to control a power level for the first and second heating devices. A power distribution circuit interposes the controller and the first and second heating devices for adjusting the power level based on a control signal from the controller.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a cooking system of the present disclosure;

FIG. 2 is a functional block diagram of a cooking system of the present disclosure;

FIG. 3 is a front perspective view of a multilevel cooking accessory of the present disclosure; and

FIG. 4 is a block diagram of a cooking system of the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a multilevel cooking accessory for a cooking system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

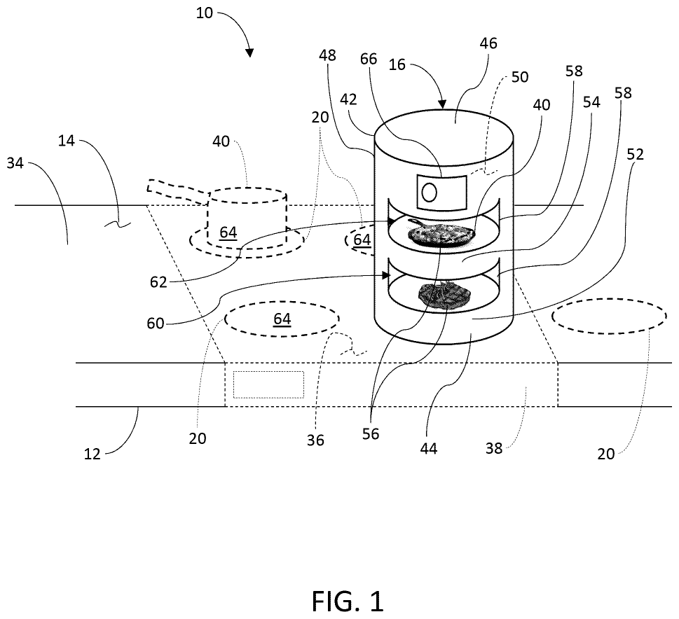

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-4, reference numeral 10 generally designates a cooking system. The cooking system 10 includes a support structure 12 having a support surface 14. The cooking system 10 further includes a cooking device 16 for placement on the support structure 12. A power transmission circuit 18 is between the support structure 12 and the cooking device 16. The power transmission circuit 18 has a first power communication coil 20 disposed in the support structure 12, a second power communication coil 22 disposed in the cooking device 16, and a power source 24 in communication with the first power communication coil 20. The first power communication coil 20 is configured to induce an electrical current in the second power communication coil 22. The cooking system 10 further includes a heat control circuit 26. The heat control circuit 26 has a first heating device 28 and a second heating device 30 disposed in the cooking device 16. The second heating device 30 is disposed above the first heating device 28. The heat control circuit 26 further includes a controller 32 in communication with the plurality of heating devices 28, 30 configured to control a power level for the first and second heating devices 28, 30.

Referring now to FIG. 1, the cooking device 16 is illustrated disposed on a countertop arrangement in a kitchen environment. The countertop arrangement includes a countertop 34 and a cooktop surface 36 of a cooktop 38. With the support structure 14 extending across the countertop 34 and the cooktop 38. The first power communication coil 20 may be disposed beneath the countertop 34 or the cooktop 36 to allow the cooking device 16 to be powered via wireless power transfer while resting on the support surface 14. In some examples, induction coils typically employed to heat cookware 40, or cooking utensils, disposed on the cooktop 38 may be employed additionally, or alternatively, for electrical power transfer. By allowing the cooking device 16 to be powered wirelessly, the cooking device 16 may serve as a cordless cooking accessory 16 that is generally portable across multiple support services, and may enhance a user experience by not requiring, for example, wired electrical connections between the cooking accessory 16 and a wall outlet.

With continued reference to FIG. 1, the cooking device 16 includes a housing 42 having a base 44, an upper portion 46, and a sidewall 48 extending therebetween. Various electrical components of the present disclosure may be incorporated into an interior 50 of the housing 42, as will be shown and described in the proceeding figures. The housing 42 may include one or more support members 52, 54 that are operable to support at least one food item 56 and/or a cooking utensil (e.g., cookware 40) thereon. The support members 52, 54 may be formed via one or more indentations 58 defined by the housing 42, as illustrated, or may protrude outwardly from the sidewall 48. In this way, multiple cooking zones 60, 62 may be provided with the cooking device 16 to allow the cooking device 16 to cook multiple food items 56 independently from one another. Further, by allowing for the plurality of cooking zones 60, 62 in the cooking device 16, when the cooking device 16 serves as a cooking accessory 16 for the induction cooktop 38, an increased number of cooking zones 60, 62 are provided than would otherwise be available, absent the cooking accessory 16. In the example depicted in FIG. 1, the induction cooktop 38 is effectively provided with an increased number of cooking regions 64 from 4 to a number more than 4 (e.g., 5, 6, or more).

The plurality of support members 52, 54, exemplarily includes a first support member 52 and a second support member 54 that are generally aligned with one another. For example, the second support member 54 may be disposed above the first support member 52 to cover at least a portion of a first cooking zone 60 of the plurality of cooking zones 60, 62. In this way, the second support member 54 may thermally isolate or limit heat transfer between the first and second cooking zones 60, 62. For example, the second support member 54 may include ceramics or other materials implemented to limit the thermal effects of the first cooking zone 60 relative to the second cooking zone 62. In other examples, the second support member 54 serves to thermally conduct heat transfer between the first and second cooking zones 60, 62 to enhance heating of the second cooking zone 62.

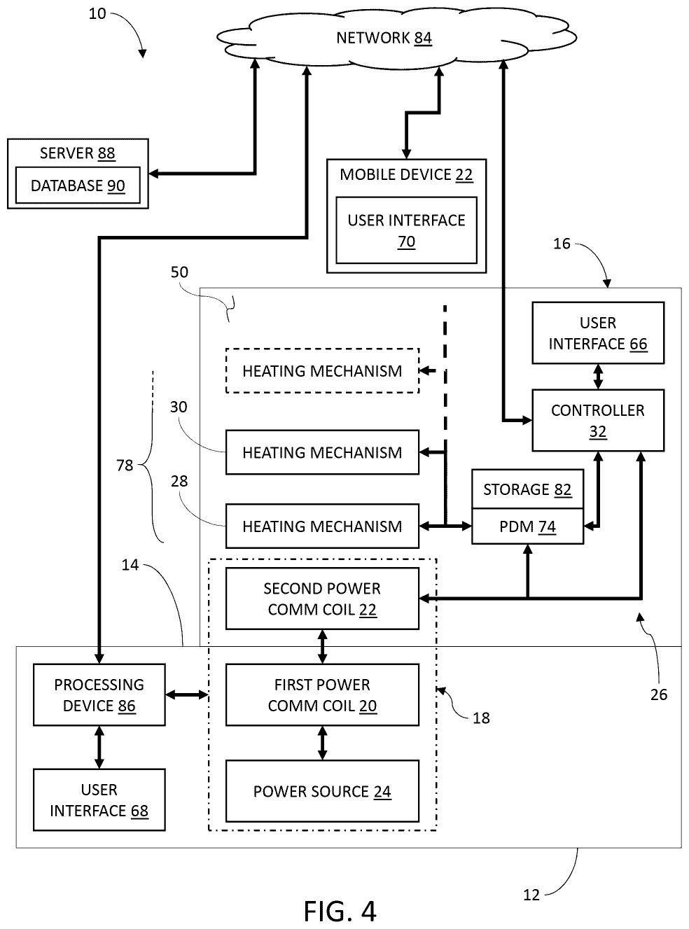

Still referring to FIG. 1, at least one user interface 66, 68, 70 may be provided for controlling functional aspects of the cooking system 10. As will be described further in relation to FIG. 4, the at least one user interface 66, 68, 70 may include a plurality of user interfaces 66, 68, 70, with a first user interface 66 disposed with the cooking device 16. In some examples, a second user interface 68 is disposed with or associated with the support structure 12 (e.g., the induction cooktop 38). As will further be described herein, a third user interface 70 may be on a mobile device 72, such as a cell phone, a tablet, or other electronic device configured for wireless communication wired or wireless communication. In some examples, the plurality of heating devices 28, 30, or heating mechanisms, includes a heater coil, a heating element, and/or a resistance heater. It is contemplated that other types of heating mechanisms may be employed in the heating device 28, 30 to heat one or more food items 56 in the cooking accessory 16. In general, the vertical distribution of the heater coils 28, 30 may allow for space optimization within a kitchen environment. For example, as illustrated in FIG. 1, a multilayer approach for the wireless cooking accessory 16 may provide for an increased number of heating regions relative to a typical number of heating regions provided for the cooktop 38.

Referring now to FIGS. 1-3, the base 44 of the cooking device 16 houses the second power communication coil 22 and is in communication with a power distribution module 74 that is configured to distribute electrical energy induced from wireless power transfer. It is contemplated that, while illustrated as having two heating mechanisms 28, 30 in the figures, the present disclosure is not limited to, and may include three, four, five, or any feasible number of heating mechanisms 28, 30 distributed within the cooking device 16.

The power distribution module 74 may include power regulation circuitry and/or one or more converter circuits that are configured to receive electrical energy from the second power communication coil 22 and reduce or otherwise adjust a power level of an electrical signal to one or more of the plurality of heater coils 28, 30. As will be further described in relation to FIG. 4, the controller 32 is in communication with the power distribution module 74 to control the power distribution module 74 to adjust the power level based on instructions executed by a processor within the controller 32. In general, communication between the controller 32 and the power distribution module 74 may be on a separate circuit from the power distribution circuitry, such that the controller 32 may be operable with a relatively low voltage (e.g., 5 VDC, 12 VDC, 24 VDC), and the power distribution circuitry 74 may be operable with a relatively high voltage (e.g., 10 VAC-120 VAC, 50 VDC-at least 500 VDC, etc.). In one example, the controller 32 is configured to control one or more switching devices, such as transistors, within the power distribution module 74 to control a current level, a voltage level, or other power level associated with each of the plurality of heating devices 28, 30. For example, the power distribution circuitry 74 may modulate the relatively high power transmission (via, e.g., pulse-width modulation (PWM)) to control an average voltage or average current provided to the heating mechanisms 28, 30. Feedback circuitry may also be incorporated between the power distribution module 74 and the controller 32 to allow the controller 32 to monitor whether the power distribution module 74 is functioning appropriately according to the instructions stored in the controller 32 and communicated to the power distribution module 74.

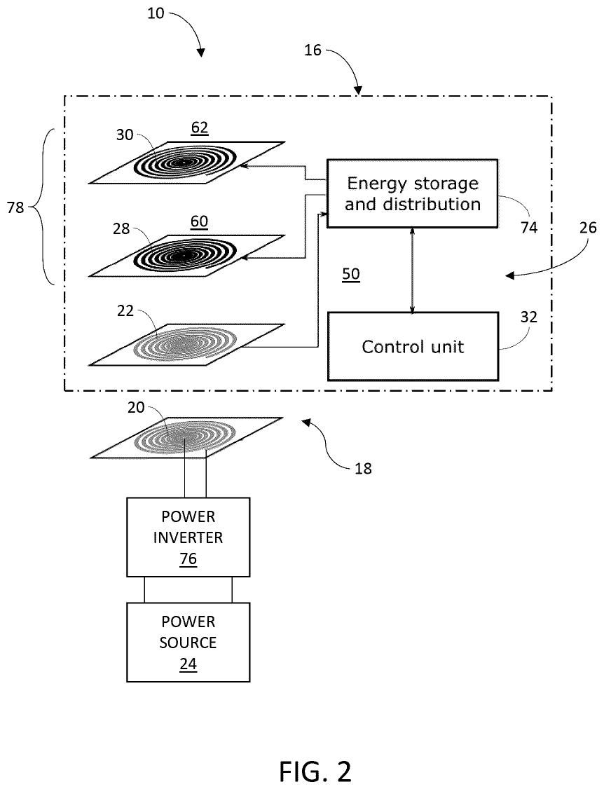

Referring still to FIGS. 1-3, the first and second heating devices 28, 30 may be disposed in the first and second support members 52, 54, respectively. It is contemplated that the first support member 52 may be integrally formed with the base 44 and not separated by an indentation 58, such that the base 44 and the first support member 52 are adjacent to one another. As illustrated in FIG. 2, the power transmission circuit 18 may also include a power inverter 76 interposing the power source 24 and the first power communication coil 20. For example, the power inverter 76 may include rectification circuitry (e.g., diodes), converter circuitry (e.g., DC-DC converters, DC-AC converters, AC-DC converters, etc.), and/or step up or step down circuitry to provide a controlled electrical signal to the first power communication coil 20. As will be described in further detail in relation to FIG. 4, the power inverter 76 and/or the power source 24 may be in communication with the controller 32 previously described or another controller part of the heat control circuit 26 to control electrical properties of signals provided to the first power communication coil 20.

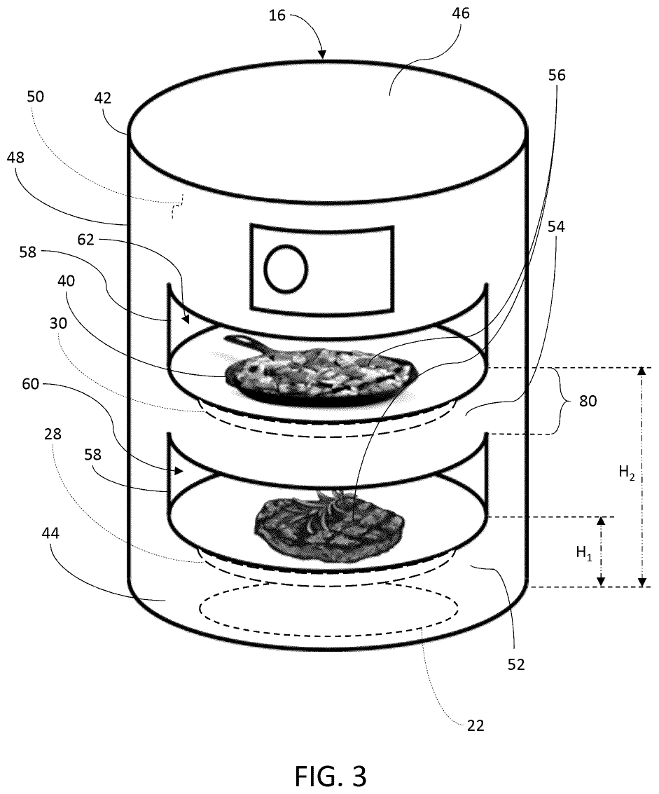

As shown in FIGS. 2 and 3, the first and second heating devices 28, 30 may be vertically arranged in an array 78. Although not depicted in detail, third, fourth, or any number of heating devices may be disposed above the base 44 and be arranged in the array 78. Each heating device may be disposed along a plurality of heights H1, H2 measured perpendicularly from the support surface 14. For example, a first heater coil (e.g., the first heating device 28) may be disposed at a first height H 1 and a second heater coil (e.g., the second heating device 30) may be disposed at a second height H2 from the support surface 14. The first height H 1 may be different from the second height H2. For example, as depicted, the first height H 1 may be less than the second height H2. In general, the difference between the first and second heights H1, H2 may account for a cooking space and for a thickness 80 of the second support member 54 to adequately allow space for cooking food items 56 in the first indentation/slot 58. In some examples, the heat control circuit 26 is powered solely via wireless power transmission by the power transmission circuit 18. In some examples, the first power communication coil 20 may be referred to as a power transfer coil, and the second power communication coil 22 may be referred to as a power receiver coil. For example, the power receiver coil 22 may operate passively to receive electrically induced currents, whereas the power transmission coil 20 may induce the electrical currents formed in the power receiver coil 22. It is also contemplated that the power receiver coil 22 may be in communication with an electro-chemical storage device 82, such as a battery, for storing excess power delivered to the cooking device 16.

Although illustrated in FIG. 3 as including the second power communication coil 22 and the pair of first and second heating devices 28, 30, it is contemplated that the power receiver coil 22 may also act as the first heating device 28 in addition to receiving electrical power for distribution to one or more of the plurality heating devices 28, 30. In this example, the heat delivered to the food item 56 in the first cooking zone 60 may be less controlled than the heat delivered to the second cooking zone 62, as a processing device 86 of the cooking device 16 (FIG. 4) may be downstream of the power received from the power transmission circuit 18. Thus, in at least one example, at least one of the plurality of heating devices 28, 30 is controlled directly via the power transmission circuit 18 from the support structure 12. In some examples, the second power communication coil 22 is configured to heat a cooking area beneath the first and second heating devices 28, 30. In some examples, the receiver coil 22 (e.g., the second power communication coil 22) is covered with a ferrite layer to contain the electromagnetic field induced by the first power by the power transmission circuit 18.

Referring now to FIG. 4, the cooking system 10 may include a network 84 that provides communication between one or more devices, such as the processing device 86 of the induction cooktop 38 and the controller 32 of the cooking device 16. The network 84 may be a wireless or wired network. For example, the network 84 may include a local area network (LAN) or a global network, such as the Internet, to allow for remote operation of the device 86 and/or local operation of the device wirelessly. The network 84 may employ Wi-Fi, 4G, 5G, 6G, TCP/IP, Ethernet, Zigbee, Bluetooth, near-field communications (NFC), or other various shortwave or longwave radio communication protocols to allow communication between various devices. In some examples, direct communication via NFC (e.g., a personal-area network, a local-area network, a wireless-area network, a home-area network, etc.) may be provided between the controller 32 and the processing device 86. The network 84 may further include one or more remote servers 88 that are configured to store data related to operation of the cooking accessory 16. For example, the one or more servers 88 may include a database 90 of cooking parameters, such as recipe data related to recipes for particular dishes, desired internal temperatures of specific food items 56, and the like.

The network 84 may provide for communication with the mobile device 72 that is configured to receive food item data related to the food to be cooked in the cooking accessory 16. For example, the mobile device 72 may include the third user interface 70 to allow the user to input types of food to be cooked and/or a particular recipe that may be prepared using the cooking accessory 16. Via the network 84, the user input data may be processed by one or more computer processors coupled with the server 88 to locate the recipe data and/or the food preparation data stored in the database 90. Accordingly, target values for the plurality of heating mechanisms 28, 30 and/or the power transmission circuit 18 may be determined based on the user inputs and communicated to the processing device 86 associated with the support structure 12 and/or the controller 32 of the cooking device 16. In general, the controller 32 may be configured to communicate a request to the processing device 82 adjust a power transfer from the power transmission circuit 18. For example, if more power is needed for hotter cooking temperatures associated with a particular recipe, the controller 32 may communicate a signal, or an instruction, to the processing device 82 via the network 84 (e.g., via NFC) to provide a higher voltage or current to the first power communication coil 20. In this way, the controller 32 in the cooking device 16 may be configured to communicate a signal to the processing device 82 to adjust the power transfer in response to a heating requirement. In some examples, NFC communication is employed for close-proximity communication when the cooking device 16 is situated on the support structure 12 or otherwise near the support structure 12. Thus, direct wireless communication may be utilized between the cooking device 16 and the support structure 12.

In some examples, the power transmission circuit 18 may be controlled to a particular global power level determined based on target recipe data entered by the user. The second power communication coil 22 may operate at the target global power level to provide power to the power distribution module 74. The controller 32 of the cooking device 16 may communicate one or more signals to the power distribution module 74 to adjust distribution of the global power level to one or more of the heating devices 28, 30. For example, the first heating mechanism 28 may be assigned to one item of a food dish (e.g., a protein, such as a steak) and have a corresponding target power level determined by the controller 32 of the cooking device 16. The second heating mechanism 30 may be associated with another item of the food dish, such as a cream sauce, having a corresponding target power level. The target power levels associated with the heating mechanisms 28, 30 may differ from one another based on a target temperature or cooking time associated with each item of the food dish based on the recipe. In this way, different amounts of heat may be provided for different foods when cooking with the multilevel cooking accessory 16 of the present disclosure.

In general, the cooking accessory 16 of the present disclosure may be used in conjunction with the induction cooktop 38 or an induction transmitter hidden beneath a working surface or countertop 34. The cooking accessory 16 may include two separate layers dedicated to cooking. The cooking accessory 16 is configured to receive energy from the first power communication coil 20. The induction coupling is able to distribute the received energy to the individual cooking layers. Each individual cooking layer includes at least one heating mechanism 28, 30, as previously described. The multiple cooking layers may be independently controlled via one or more of the controllers 32 previously described. The controller 32 may control the various heating levels based on user inputs related to power and/or temperature settings. The control of the individual layers may be executed based on the settings received from one or more of the user interfaces 66, 68, 70 previously described.

The multilevel cooking accessory 16 of the present disclosure may provide for expanded functionality and an increased cooking area. Further, by providing an active cooking accessory 16, functionality is not limited to passive heating of other heating areas from a common heat source or lack of individualized control, but rather may provide for individualized control of multiple cooking areas, or layers, powered from a common power source. Thus, the controller 32 of the multilevel cooking accessory 16 may provide for more accurate control of a cooking process. Lastly, the various spatial features of the cooking accessory 16 (e.g., the indentations 58 and support members 52, 54) may allow for receiving different types of cookware 40, including large cookware 40 such as pots, pans, and the like.

According to one aspect of the present disclosure, a cooking system includes a support structure that has a support surface. The cooking system further includes a cooking device for placement on the support structure. The cooking system further includes a power transmission circuit between the support structure and the cooking device. The power transmission circuit has a first power communication coil disposed in the support structure, a second power communication coil that is disposed in the cooking device, and a power source that is in communication with the first power communication coil. The first power communication coil is configured to induce an electrical current in the second power communication coil. A heat control circuit that includes a first heating device and a second heating device that are disposed in the cooking device. The second heating device is disposed above the first heating device. A controller that is in communication with the first and second heating devices that are configured to control a power level for the first and second heating devices.

According to some aspects, the cooking system includes the first and second heating devices that are vertically arranged in an array.

According to some aspects, the array includes a first heater coil disposed at a first height from the support surface and a second heater coil disposed at a second height from the support surface. The first height may be different than the second height.

According to some aspects, the cooking system further includes a housing having a base, a first support member, and a second support member. The base houses the second power communication coil, the first support member houses the first heating device, and the second support member houses the second heating device.

According to some aspects, the cooking system further includes the first and second supports that are aligned with one another.

According to some aspects, the cooking system further includes first and second cooking zones. The first cooking zone is heated via the first heating device, and the second cooking zone is heated via the second heating device. The first cooking zone is disposed below the second heating device and the second cooking zone.

According to some aspects, the second support member at least partially covers the first cooking zone.

According to some aspects, the first and second heating devices include at least one of a heater coil, a heating element, and a resistance heater.

According to some aspects, the cooking device includes first and second cooking zones associated with the first and second heating devices.

According to some aspects, the heat control circuit includes a power distribution unit in communication with the controller. The controller is configured to communicate an instruction to adjust the power distribution unit based on a target heat level.

According to some aspects, the power transmission circuit includes a processing device configured to control a power transfer to the cooking device via wireless power transmission. The controller is disposed in the cooking device and is further configured to communicate a signal to the processing device to adjust the power transfer in response to a heating requirement.

According to some aspects, the support structure is an induction cooktop of a cooking appliance.

According to some aspects, the support surface is a countertop.

According to some aspects, the cooking system further includes a user interface that is in communication with the heat control circuit and the power transmission circuit. The user interface is operably coupled with the support structure and configured to receive a target heat level for the first and second heating devices.

According to some aspects, the second power communication coil is configured to heat a cooking region below the first and second heating devices.

According to another aspect of the present disclosure, a wireless cooking accessory includes a housing having a base, a first support member, and a second support member. A power receiver coil is disposed in the base and configured to receive electrical power via induction power transfer. A heat control circuit that has a plurality of heating devices disposed in the housing and a controller that is in communication with the plurality of heating devices. The controller is configured to control a power level for each of the plurality of heating devices. The plurality of heating devices are arranged in a vertical array.

According to another aspect, the wireless cooking accessory includes the plurality of heating devices which include a first heater coil disposed in the first support member and a second heater coil disposed in the second support member.

According to another aspect, the wireless cooking accessory further includes the first and second cooking zones. The first cooking zone is heated via the first heater coil and the second cooking zone is heated via the second heater coil. The first cooking zone is disposed below the second heater coil and the second cooking zone.

According to another aspect, the wireless cooking accessory includes the power receiver coil that is configured to heat a cooking region below the plurality of heating devices.

According to yet another aspect of the present disclosure, a system for a multilevel cooking accessory that includes an induction cooktop that has a cooktop surface. A power transmission circuit is between the induction cooktop and the multilevel cooking accessory. The power transmission circuit includes a first power communication coil that is disposed in the induction cooktop. A second power communication coil is disposed in the multilevel cooking accessory. A power source is in communication with the first power communication coil. The first power communication coil is configured to induce an electrical current in the second power communication coil. A heat control circuit is powered by the power transmission circuit that includes a first heating device and a second heating device that are disposed in the multilevel cooking accessory. The second heating device is disposed above the first heating device. A controller is in communication with the first and second heating devices that are configured to control a power level for each of the first and second heating devices. A power distribution circuit interposes the controller and the first and second heating devices for adjusting the power level based on a control signal from the controller.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooking system, comprising:
a support structure having a support surface;
a cooking device for placement on the support structure;
a power transmission circuit between the support structure and the cooking device, the power transmission circuit having a first power communication coil disposed in the support structure, a second power communication coil disposed in the cooking device, and a power source in communication with the first power communication coil, wherein the first power communication coil is configured to induce an electrical current in the second power communication coil; and
a heat control circuit, comprising:
a first heating device and a second heating device disposed in the cooking device, the second heating device disposed above the first heating device; and
a controller in communication with the first and second heating devices and configured to control a power level for the first and second heating devices.

2. The cooking system of claim 1, wherein the first and second heating devices are vertically arranged in an array.

3. The cooking system of claim 2, wherein the array includes a first heater coil disposed at a first height from the support surface and a second heater coil disposed at a second height from the support surface, the first height being different than the second height.

4. The cooking system of claim 1, further comprising:
a housing having a base, a first support member, and a second support member, wherein the base houses the second power communication coil, the first support member houses the first heating device, and the second support member houses the second heating device.

5. The cooking system of claim 4, wherein the first and second supports are aligned with one another.

6. The cooking system of claim 4, further comprising:
first and second cooking zones, wherein the first cooking zone is heated via the first heating device and the second cooking zone is heated via the second heating device, the first cooking zone disposed below the second heating device and the second cooking zone.

7. The cooking system of claim 6, wherein the second support member at least partially covers the first cooking zone.

8. The cooking system of claim 4, wherein the first and second heating devices include at least one of a heater coil, a heating element, and a resistance heater.

9. The cooking system of claim 1, wherein the cooking device includes a first and second cooking zones associated with the first and second heating devices.

10. The cooking system of claim 1, wherein the heat control circuit includes a power distribution unit in communication with the controller, and wherein the controller is configured to communicate an instruction to adjust the power distribution unit based on a target heat level.

11. The cooking system of claim 1, wherein the power transmission circuit includes a processing device configured to control a power transfer to the cooking device via wireless power transmission, wherein the controller is disposed in the cooking device and is further configured to communicate a signal to the processing device to adjust the power transfer in response to a heating requirement.

12. The cooking system of claim 11, wherein the support structure is an induction cooktop of a cooking appliance.

13. The cooking system of claim 11, wherein the support surface is a countertop.

14. The cooking system of claim 11, further comprising:
a user interface in communication with the heat control circuit and the power transmission circuit, the user interface operably coupled with the support structure and configured to receive a target heat level for the first and second heating devices.

15. The cooking system of claim 1, wherein the second power communication coil is configured to heat a cooking region below the first and second heating devices.

16. A wireless cooking accessory, comprising:
a housing having a base, a first support member, and a second support member;
a power receiver coil disposed in the base and configured to receive electrical power via induction power transfer; and
a heat control circuit having a plurality of heating devices disposed in the housing and a controller in communication with the plurality of heating devices, the controller configured to control a power level for each of the plurality of heating devices, wherein the plurality of heating devices are arranged in a vertical array.

17. The wireless cooking accessory of claim 16, wherein the plurality of heating devices includes a first heater coil disposed in the first support member and a second heater coil disposed in the second support member.

18. The wireless cooking accessory of claim 17, further comprising:
first and second cooking zones, wherein the first cooking zone is heated via the first heater coil and the second cooking zone is heated via the second heater coil, the first cooking zone disposed below the second heater coil and the second cooking zone.

19. The wireless cooking accessory of claim 16, wherein the power receiver coil is configured to heat a cooking region below the plurality of heating devices.

20. A system for a multilevel cooking accessory, comprising:
an induction cooktop having a cooktop surface;
a power transmission circuit between the induction cooktop and the multilevel cooking accessory, the power transmission circuit comprising:
a first power communication coil disposed in the induction cooktop;
a second power communication coil disposed in the multilevel cooking accessory, and
a power source in communication with the first power communication coil, wherein the first power communication coil is configured to induce an electrical current in the second power communication coil; and
a heat control circuit powered by the power transmission circuit, comprising:
a first heating device and a second heating device disposed in the multilevel cooking accessory, the second heating device disposed above the first heating device;
a controller in communication with the first and second heating devices configured to control a power level for each of the first and second heating devices; and
a power distribution circuit interposing the controller and the first and second heating devices for adjusting the power level based on a control signal from the controller.
